(19) United States
(12) Patent Application Publication
(10) Pub. No.: US 2022/0074034 A1
(43) Pub. Date: Mar. 10, 2022

(54) Steel for Surface Hardening, Having a High Edge Hardness and Having a Fine Ductile Grain Structure

(71) Applicant: EZM Edelstahlzieherei Mark GmbH, Wetter (DE)

(72) Inventor: Serosh Engineer, Krefeld (DE)

(21) Appl. No.: 17/277,005

(22) PCT Filed: Sep. 17, 2019
(86) PCT No.: PCT/EP2019/074872

§ 371 Date: Mar. 17, 2021

(30) Foreign Application Priority Data
Sep. 18, 2018 (DE) 10 2018 122 858.9

(51) Int. Cl. C22C 38/54; C22C 38/44; C22C 38/02; C22C 38/04; C22C 38/06; C22C 38/00; C21D 9/00

(52) U.S. Cl. CPC C22C 38/54; C22C 38/44; C22C 38/02; C21D 9/0068; C22C 38/06; C22C 38/001; C22C 38/04

(57) ABSTRACT

The invention makes a steel available, which, in the case of edge-layer hardening without subsequent relaxation annealing, not only has the potential for developing a hardened edge layer having a great surface hardness, in particular a surface hardness that amounts to more than 820 HV1, but rather also possesses a ductile, fine-grained grain structure and, at the same time, can be easily welded. For this purpose, a steel according to the invention consists of (in weight %) C: 0.10-0.19%, Si: ≤0.15%, Mn: ≤1.0%, P: ≤0.015%, S: ≤0.015%, Cr: 0.2-1.0%, Ni: 0.7-2.0%, Mo: 0.5-1.0%, N: ≤0.015%, Al: 0.010-0.060%, Cu: ≤0.20%, B: ≤0.005%, as well as optionally, in each instance, one or more elements from the group “W, Ti, Nb, V, Ta” in content values in accordance with the following stipulations: W: 0.15-0.65%, Ti: 0.01-0.04%, Nb: 0.015-0.05%, Ta: 0.01-0.04%, V: 0.04-0.12%, and, as the remainder, of iron and unavoidable contaminants.

### CROSS-REFERENCE TO RELATED APPLICATIONS

This application is the United States national phase of International Application No. PCT/EP2019/074872 filed Sep. 17, 2019, and claims priority to German Patent Application No. 10 2018 122 858.9 filed Sep. 18, 2018, the disclosures of which are hereby incorporated by reference in their entirety.

### BACKGROUND OF THE INVENTION

### Field of the Invention

The invention relates to a steel that is suitable for edge-layer hardening and, in this process, makes great hardness at the surface and a great hardness penetration depth possible.

### Description of Related Art

In particular, the invention relates to a steel that has the potential for developing a hardened edge layer having a surface hardness of more than 820 HV1 according to DIN EN ISO 2639, and, at the same time, has a fine grain structure that carries the hardened edge layer, which structure is characterized by great ductility and thereby makes the steel capable of withstanding great sudden stresses.

Methods for case-hardening are explained in the bulletin 452. “Einsatzhärten” [“Case-hardening” ], Edition 2008, ISSN 0175-2006, published by the Stahl-Informations-Zentrum [Steel Information Center]. In what is called “direct hardening,” the steel is heated to a carburizing temperature that generally lies between 900 and 1050° C., and then cooled quickly directly afterward. In the case of gas carburization under vacuum, the material is cooled by blowing in helium at high pressure. Relaxation annealing follows, which serves to reduce inherent stresses and to increase ductility.

Another method for edge-layer hardening, in which the hardness of the edge layer is also increased by means of carburization, is what is called “simple hardening.” In this method, the material is heated, after having cooled down from the case-hardening heat to a temperature that is coordinated with the edge carbon content, and subsequently is rapidly cooled.

In practice, “direct hardening” is increasingly being used, since it is the more efficient method. In this process, an attempt is made to do without the relaxation annealing that usually takes place after hardening.

However, direct hardening without subsequent relaxation annealing makes greater demands on the material than single hardening does. In order to obtain the greatest possible hardness, the chemical composition of the material must be coordinated for direct hardening carried out without subsequent relaxation annealing, in such a manner that the residual austenite content in the hardened zone is as low as possible. At the same time, the grain structure of the steel must remain very ductile or impact-resistant, so as to withstand sudden stresses. Furthermore, the chemical composition of the material must also demonstrate sufficient hardenability.

In current practice, case-hardened components are produced, for example, from the steel known under the designation “14CrNiMo5”, which consists, according to element analysis, of (in wt %) 0.12% C, 1.40% Cr, 0.30% Mo, and 1.6% Ni, remainder iron and unavoidable contaminants. However, in the case of this steel, the required great surface hardness values are not achieved with the required reliability after direct hardening.

The German standard DIN 17115 (current edition 2012-07) concerns itself with the technical delivery conditions for steels for welded round steel chains and individual parts of chains. In this standard, stainless steels for annealing treatment are listed, among other things. The steel 15CrNi6 (Material-No. 1.5919: (content information in wt %) C: 0.12-0.18, Si: ≤0.25, Mn: 0.40-0.70, P: ≤0.020, S: ≤0.015, Cr: 1.35-1.65, Ni: 1.35-1.65, N: ≤0.012, Cu: ≤0.020; remainder Fe) is a material that can be used for producing case-hardened round steel chains. However, this steel also does not achieve the surface hardness of >820 HV1 that is at least required after direct hardening. The materials listed in the delivery conditions, such as, for example 20MnCrMo3-2 (1.6522: (content information in wt %) C: 0.17-0.23, Si: ≤0.40, Mn: 0.60-0.95, P≤0.025, S: ≤0.015, Cr: 0.35-0.65, Mo: 0.15-0.25, No: 0.40-0.70, Al: ≤0.050, Cu: ≤0.30, remainder Fe), 23MnNiCrMo5-3 (1.6540: (content information in wt %) C: 0.20-0.26, Si: ≤0.25, Mn: 1.1-1.40, P: ≤0.020, S: ≤0.015, Cr: 0.4-0.6, Mo: 0.20-0.30, Ni: 0.70-0.90, N: ≤0.012, Al: 0.025-0.50, Cu: ≤0.20, remainder Fe) or 23MnNiCrMo5-4 (1.6758: (content information in wt %) C: 0.20-0.26, Si: ≤0.25, Mn: 1.10-1.40, P: ≤0.020, S: ≤0.015, Cr: 0.40-0.60, Ni: 0.90-1.10, N: ≤0.012, Al: 0.025-0.050, Cu: ≤0.20, remainder Fe) are more suitable for chains that are used in the annealed state.

From EP 1905857B1, a further high-strength steel is known, containing (in wt %) C: 0.15-0.3%, Si: 0.1-0.5%, Mn: 0.6-1.8%, Cr: 1.0-1.8%, Mo: 0.10-0.50%, Ni: up to 0.50%, Nb: 0.030-0.150%, Ti: 0.020-0.060%, Al: 0.010-0.060%, N: 0.008-0.030%, P: <0.030%, S: <0.030%, remainder iron and unavoidable contaminants. This steel also does not achieve the required high surface quality of more than 820 HV1 during direct hardening from the heat of the operation. Furthermore, the experiments show that the hardness of the grain structure is too high, at 425 HV, and concomitantly the impact resistance of the grain structure is too low to withstand high sudden rupture stresses.

Against this background, the task has arisen of developing a steel that not only has the potential of developing a hardened edge layer having a high surface hardness, in particular one that amounts to more than 820 HV1, during edge-layer hardening without subsequent relaxation annealing, but also possesses an impact-resistant, fine-grained grain structure and, at the same time, can be easily welded.

The properties of the steel according to the invention are supposed to make it particularly suitable for the production of chains and individual parts of chains, for areas of use of the type described in DIN 17115.

The invention has accomplished this task by means of a steel having the composition as described herein.

### SUMMARY OF THE INVENTION

A steel according to the invention, which fulfills the requirements stated above, accordingly consists of (in weight %)
C: 0.10-0.19%
Si: ≤0.15%
Mn: ≤1.0%
P: ≤0.015%
S: ≤0.015%
Cr: 0.2-1.0%
Ni: 0.7-2.0%
Mo: 0.5-1.0%
N: ≤0.015%
Al: 0.010-0.060%
Cu: ≤0.20%
B: ≤0.005%
as well as optionally, in each instance, one or more elements from the group “W, Ti, Nb, V, Ta” in a content in accordance with the following stipulations
   W: 0.15-0.65%
   Ti: 0.01-0.04%
   Nb: 0.015-0.05%
   Ta: 0.01-0.04%
   V: 0.04-0.12%
remainder iron and unavoidable contaminants.

The steel according to the invention has a composition such that it achieves the required great hardness of more than 820 HV1 at the surface by means of edge-layer hardening, which is carried out, for example, as case-hardening, nitriding or carbonitriding.

At the same time, great hardness is still present even at a great hardness penetration depth, as it is generally required in working the steel according to the invention to produce heavy chains and individual parts of chains, which are intended to be used, for example, as conveyor chains or transport chains in mining, in machine construction or the like.

Thus, in the case of edge-layer hardening of a sample rod formed from a steel according to the invention, a hardness penetration depth of 0.30-0.45 mm is achieved at rod dimensions up to 45 mm diameter at a hardness of 550 HV.

In this regard, steel according to the invention typically has a structure in the grain, after edge-layer hardening, that essentially consists of fine-grained, ductile martensite and bainite and is characterized by a grain size, determined according to the standard ASTM E112, of typically 6 and finer.

A steel according to the invention has great suitability for welding. Thus, it can easily be welded, for example in the production of chain links, by means of flash butt welding or resistance butt welding.

In order to develop the required hardness at the surface of the hardened edge layer, at least 0.10 wt % carbon (“C”) is required. Here, it has been shown in experiments that low C content values of up to 0.13 wt % are advantageous for many applications of the steel according to the invention. In other applications, optimal effects of the presence of C in the steel according to the invention occur if the C content amounts to at least 0.12 wt %. At C content values that lie above 0.19 wt %, the danger exists that the grain hardness of the steel increases too greatly, and the ductility or impact resistance of the grain structure is impaired. Furthermore, the restriction to at most 0.19 wt % C, in particular less than 0.19 wt % C, contributes to good weldability of the steel. An optimized embodiment of the invention provides that the C content is restricted to at most 0.16 wt %, in particular at most 0.13 wt %, so as to minimize any negative influence of C on the properties of the steel.

The content of silicon (“Si”) of a steel according to the invention should be as low as possible, since silicon leads to solidification of the grain structure. Such an increase in solidification proves to be particularly harmful if no relaxation annealing is carried out after edge-layer hardening.

Manganese (“Mn”) can be added to the steel according to the invention in order to increase its hardenability. Since Mn lowers the conversion temperatures to the ferrite, perlite, and martensite stage, the Mn content is restricted to at most 1.0 wt %, according to the invention. In order to reliably make use of the advantageous effects of Mn in a steel according to the invention, its Mn content can be raised to at least 0.7 wt % Mn.

The content of phosphorus (“P”) is kept as low as possible in a steel according to the invention, since P causes strong solidification of the grain structure after cooling from the case-hardening heat in the case of edge-layer hardening. In order to prevent this, the P content of the steel according to the invention is restricted to at most 0.015 wt %, in particular less than 0.015 wt %.

The content of sulfur (“S”) should also be set as low as possible in a steel according to the invention, since S reduces the ductility or impact resistance of the grain structure. In order to prevent this, the S content of the steel according to the invention is also restricted to at most 0.015 wt %, in particular less than 0.015 wt %.

The content of chromium (“Cr”) is restricted to at most 1.0 wt % in the steel according to the invention, so as to guarantee a low residual austenite content in the hardened edge layer after edge-layer hardening. This effect can be achieved in particularly reliable manner if the Cr content of the steel is restricted to at most 0.6 wt %, in particular 0.5 wt %. The loss in hardenability of the steel that is to be expected as a result of the low Cr content is balanced out, in the steel according to the invention, by adjusting the content values of the other alloy elements. At the same time, at least 0.2 wt %, in particular at least 0.3 wt % or at least 0.4 wt % Cr is provided in the steel, so as to make use of the contribution to hardness that Cr can make.

Nickel (“Ni”) in the content values provided according to the invention, 0.7-2.0 wt %, contributes to increasing hardenability and to increasing ductility or impact resistance. In combination with their lower carbon content values, in the case of steels according to the invention a martensite structure is partially achieved, with slight distortion of the hardened grain structure. However, in this regard the Ni content values, just like the Mn content values, must lie within certain limits, since Ni and Mn shift the conversion points toward lower temperatures. The martensite starting temperature (Ms temperature) can be determined in accordance with the formula by Dr. Helmut Brandis indicated in Thyssen Edelstahl—Technische Berichte [Thyssen Stainless Steel Technical Reports], Volume 1, 1975, Issue 1, page 8-10. In the case of steel according to the invention, it lies at approximately 440° C. and is thereby still so high that self-annealing of the converted martensite/bainite can occur during cooling from the carburization heat. This effect increases the ductility or impact resistance as well as the long-term strength of the converted hardened grain structure, and reduces warping of the component. At the same time, at the content values of Ni predetermined according to the invention, it is ensured that the hardness of the grain structure remains low, so that the steel is able to withstand great sudden stresses even in the edge-layer-hardened state. This property makes the steel according to the invention particularly suitable for components that are not subjected to relaxation annealing after cooling from the hardening heat. By raising the Ni content to at least 0.9 wt %, in particular at least 1.5 wt %, the advantageous effects of Ni can be utilized in particularly reliable manner. In contrast, restriction of the Ni content to at most 1.8 wt % prevents negative influences of the presence of Ni in particularly reliable manner.

Molybdenum (“Mo”) changes the conversion temperatures hardly at all, but reinforces the conversion to the bainite stage after cooling from the heat of the heat treatment carried out for edge-layer hardening. A fine-grained hardened grain structure composed of bainite increases the ductility or impact resistance in the core region of the component formed from the steel according to the invention, as the result of the lesser distortion of the grain structure. Furthermore, the friction-wear behavior of the hardened edge layer is improved by means of molybdenum. The positive effects of Mo on the steel according to the invention can be utilized by means of Mo content values of at least 0.5 wt %. In contrast, negative influences of the presence of Mo in the steel according to the invention are precluded in that the Mo content is restricted to at most 1.0 wt %, in particular at most 0.9 wt % or at most 0.65 wt %.

Nitrogen (“N”) should be present as little as possible in the steel according to the invention, so as to be able to optimally utilize the hardness-increasing effect of the boron content provided according to the invention in the steel according to the invention. For this reason, the N content of a steel according to the invention is restricted to at most 0.015 wt %, in particular at most 0.010 wt %. In order to ensure the full hardenability-increasing effect of boron in the case of its presence in the steel according to the invention, the N content can be bound by alloying in micro-alloy elements such as Al and Ti, for example.

Aluminum (“Al”) is used for deoxidation in steel production. For this purpose, Al content values of 0.010-0.060 wt %, in particular at least 0.015 wt % or at most 0.040 wt % are needed, and, at the same time, they can be used for binding excess nitrogen and for increasing the fine grain.

Copper (“Cu”) is an undesirable accompanying element that gets into the melt, during melting of the steel, by way of the scrap that is used in this process. In order to prevent negative influences of Cu on the properties of the steel according to the invention, the Cu content is restricted to at most 0.20 wt %.

The content of boron (“B”) that is optionally provided, according to the invention, also serves to increase hardenability. In order for the B content to be effective, the content of N must be as low as possible, and the nitrogen that is present in the steel must be bound by means of aluminum or other elements, such as, for example, titanium, niobium or vanadium, which are optionally added. The positive influences of B can then be utilized in particularly reliable manner, if the B content amounts to at least 0.001 wt %, in particular at least 0.002 wt %. In this regard, the B content is restricted to at most 0.005 wt %, so as to prevent the formation of boron-containing excretions at the grain boundaries.

To increase the fine grain of the grain structure, which is of great importance for the ductility or impact resistance of a component formed from a steel according to the invention, elements such as niobium (“Nb”), tantalum (“Ta”), vanadium (“V”), titanium (“Ti”) or also tungsten (“W”)—alone or in combination—can also be optionally added. If a particularly fine-grained grain structure is supposed to be ensured, accordingly preferably at least one of the elements W, Ti, Nb, Ta or V is present in the steel according to the invention, as provided by the invention, wherein a combination of the elements W, Nb and V added in the manner according to the invention has proven to be particularly suitable in practice.

In this regard, the optionally added content values of Nb lie at 0.015-0.05 wt %, in particular 0.015-0.03 wt %.

The optionally added content values of Ti amount to 0.01-0.04 wt %, in particular 0.015-0.035 wt %.

The optionally added content values of V amount to 0.04-0.12 wt %, in particular 0.05-0.12 wt % or 0.08-0.12 wt %.

If Nb and V are added at the same time, their content values optimally lie at 0.015-0.03 wt % Nb and 0.08-0.12 wt % V, in order to utilize the combined effect of their presence in particularly effective manner.

The optionally added content values of Ta amount to 0.01-0.04 wt %.

The optionally added content values of W can amount to 0.15-0.65 wt %, in particular 0.15-0.35 wt %. The addition of W brings about not only a grain-fining effect, but also greater friction-wear resistance and a greater hardness penetration depth after carburization.

The content of all other elements not mentioned here, which can occur in a steel according to the invention, should be classified as contaminants, and they are restricted, in terms of the content values, in such a manner that they have no influence on the properties of the steel according to the invention. Typically, in a steel according to the invention the content values of contaminants are restricted in accordance with DIN 17 115 (Edition 2012-07) for this purpose.

Carburizing methods, as they are explained in the bulletin 452 already mentioned above, are particularly suitable for edge-layer hardening of a steel according to the invention.

The steel according to the invention can be used, in particular, for the production of case-hardened gear mechanism parts as well as other case-hardened components, such as, for example, high-strength, weldable round steel chains. In this process, subsequent relaxation annealing is not required, in each instance, to guarantee the required ductility of the material for the corresponding component. Therefore, steel according to the invention is particularly suitable for the production of case-hardened components that require great edge-layer hardness and great ductility in the core region of the components. Examples of this are the round steel chains that have already been mentioned and their individual parts, if these are intended, in particular, for use as conveying chains in cement production, mining or the processing of coal, in particular in coal gasification.

Components that are subjected to other surface treatments for edge-layer hardening, such as, for example, nitriding or carbonitriding, can also be produced from the steel according to the invention, wherein here, too, relaxation annealing does not need to be carried out after edge-layer hardening.

The invention is particularly suitable for the production of heavy, case-hardened round steel chains for use in mining, in the cement industry or in coal gasification.

Likewise, highly wear-resistant drive chains, having a high load capacity, for vehicles, in particular motor vehicles, motorcycles, and bicycles, can be produced from the steel according to the invention.

In this regard, the surface hardness of the steel can be brought to values of more than 820 HV1, in reliable manner, in that the component formed from the steel according to the invention, in each instance, the edge layer of which has been hardened by means of case-hardening, is cooled in oil or helium after the edge-layer hardening. In the grain structure, consisting of bainite and martensite, of a sample rod consisting of the steel according to the invention, the edge layers of which have been hardened, which rod has a diameter of up to 45 mm, a hardness of typically 200-350 HV is typically present in this case. The hardness penetration depth amounts to 0.30-0.45 mm in the case of rods up to a diameter of 45 mm.

Accordingly, a steel according to the invention has a hardness of more than 820 HV1, for example in the carburized edge layer, without subsequent relaxation. At a hardness penetration depth von 0.12% of the diameter of the corresponding component, in particular a rod-shaped component, a hardness of at least 550 HV is still present, in this regard.

In the case of chain links formed from steel according to the invention, which links have been hardened in their edge layer by means of case-hardening, and which have been cooled in oil or helium after edge-layer hardening that took place in a vacuum, a rupture strength of at least 440 MPa can be achieved in a chain test conducted according to DIN 22252.

A steel according to the invention has a notched bar impact work of at least 50 joules, in particular at least 90 joules, determined according to the standard DIN EN ISO 148-1, with notched bar impact work values of 110-130 joules regularly being achieved, after blank-hardening, i.e., case-hardening in which the steel is heated to the hardening temperature without carburization.

In the following, the invention will be explained using an exemplary embodiment.

To check the properties of a steel according to the invention, hot-rolled rod steel having a circular diameter of 30 mm, in other words a diameter that is representative for chain links or the like, was produced in conventional manner, which had the composition indicated in Table 1, which satisfies the requirements of the invention (information in weight %, remainder iron and unavoidable contaminants):

TABLE 1

| C | Si | Mn | P | S | Cr |
|---|---|---|---|---|---|
| 0.12 | 0.12 | 0.51 | 0.008 | 0.005 | 0.41 |
| Ni | Mo | Al | N | W | Cr |
| 1.71 | 0.52 | 0.033 | 0.011 | 0.030 | 0.41 |

The following properties were found for the rod steel:

After direct case-hardening at 950° C. with subsequent cooling in oil, a fine-grained grain structure of at least ASTM 6 is present in the rod, in the case-hardened edge layer, having a surface hardness of 840 HV1.

In the core of the sample, a hardness of 30 HRc is achieved, whereas in a hardness penetration depth of 0.38 mm, a hardness of 560 HV is present.

The composition of the steel being investigated here thereby guarantees sufficiently great ductility of the material so that subsequent relaxation for adjusting the mechanical properties is not necessary. Thus, notched bar impact work values with an ISO-V notch of 110 to 130 joules are achieved with the rod steel being investigated.

In this regard, the steel according to the invention reaches a tensile strength of 985 MPa, determined according to DIN EN ISO 17022-3, for the rod being investigated, in the “blank-hardened state” (i.e., hardening at 950° C. with subsequent cooling in oil, no carburization).

These properties as determined make the steel according to the invention particularly suitable for the production of round steel chains that achieve a rupture strength of more than 440 MPa in a chain test according to DIN 22252.

1. A steel containing (in weight-%)
C: 0.10-0.19%,
Si: ≤0.15%,
Mn: ≤1.0%,
P: ≤0.015%,
S: ≤0.015%,
Cr: 0.2-1.0%,
Ni: 0.7-2.0%,
Mo: 0.5-1.0%,
N: ≤0.015%,
Al: 0.010-0.060%,
Cu: ≤0.20%,
B: ≤0.005%
as well as optionally, in each instance, one or more elements from the group “W, Ti, Nb, V, Ta” in a content in accordance with the following stipulations
W: 0.15-0.65%,
Ti: 0.01-0.04%,
Nb: 0.015-0.05%,
Ta: 0.01-0.04%,
V: 0.04-0.12%,
remainder iron and unavoidable contaminants.

2. The steel according to claim 1, characterized in that its C content amounts to at most 0.13 wt %.

3. The steel according to claim 1, characterized in that its Cr content amounts to at least 0.3 wt %.

4. The steel according to claim 1, characterized in that its Cr content amounts to at most 0.5 wt %.

5. The steel according to claim 1, characterized in that its Ni content amounts to at least 1.5 wt %.

6. The steel according to claim 1, characterized in that its Mo content amounts to at most 0.65 wt %.

7. The steel according to claim 1, characterized in that its W content amounts to at most 0.35 wt %.

8. The steel according to claim 1, characterized in that its Nb content amounts to at most 0.03 wt %.

9. The steel according to claim 1, characterized in that its V content amounts to at least 0.08 wt %.

10. The steel according to claim 1, characterized in that its V content amounts to at most 0.12 wt %.

11. The steel according to claim 1, characterized in that in the case-hardened state, it has a surface hardness of at least 820 HV1 in a carburized edge layer without subsequent relaxation, and has a hardness of at least 550 HV at a hardness penetration depth that corresponds to 0.12% of the diameter of the component, in each instance.

12. The steel according to claim 1, characterized in that in the blank-hardened state, it has a tensile strength of at least 950 MPa.

13. The steel according to claim 1, characterized in that in the blank-hardened state, it achieves a notched bar impact work with an ISO-V notch of more than 90 joules.

14. The steel according to claim 1, characterized in that in the chain test of case-hardened round steel chains according to DIN 22252, it achieves a rupture strength of at least 440 MPa.

15. A use of a steel configured in accordance with claim 1, for producing round steel chains and individual parts.
